(19) United States
(12) Patent Application Publication
(10) Pub. No.: US 2002/0181466 A1
(43) Pub. Date: Dec. 5, 2002

(54) System for converting a fuzzy address into a precise address and completing a communication or delivery

(76) Inventors: Simon Neustein, New York, NY (US); Nathaniel Polish, New York, NY (US)

Correspondence Address: STAAS & HALSEY LLP, 700 11TH STREET, NW, SUITE 500, WASHINGTON, DC, 20001, US

(21) Appl. No.: 10/117,330

(22) Filed: Apr. 8, 2002

Related U.S. Application Data
(60) Provisional application No. 60/281,806, filed on Apr. 6, 2001.

(51) Int. Cl. H04L 12/56; H04L 12/28

(52) U.S. Cl. 370/393

(57) ABSTRACT

The present invention is a system that completes a communication initiated with an insufficient partial/incomplete or fuzzy destination address. A fuzzy address processor breaks the fuzzy address into the tokens, assigns the tokens as an index component, a disambiguation component or an other component and uses the components to perform one or more address information database searches to find records with similar address information. The records found are compared to the original fuzzy address and the record with the closest match is used as the record from which a complete address is obtained. The best match is determined using a lowest score of a lexical rewrite distance metric. The complete address is used to forward or send the communication to the destination.

### CROSS-REFERENCE TO RELATED APPLICATION(S)

This application is related to and claims priority to U.S. provisional application entitled A Method And System For Converting A Fuzzy Address Into An Actual Address having serial No. 60/281,806, by Shimon Neustein and Nathaniel Polish, filed Apr. 6, 2001 and incorporated by reference herein.

### BACKGROUND OF THE INVENTION

1. Field of the Invention

The present invention is directed to determining precise information needed for a task from imprecise information and, more particularly, to completing a communication between a source and destination by determining a complete destination address from ambiguous address information.

2. Description of the Related Art

Today communication between individuals or other entities, particularly communication based on an electronic address, is based on having a precise address for the destination of the individual. If a precise address is not known, the task of the system, the delivery of the message or good, cannot be accomplished. For example, a sender must have a complete email address of a person to whom a message is to be sent. Another example is a delivery or communication of a courier package where the courier service allows senders to enter a destination address via an access to the courier's web site. A further example of a required precise address is a telephone number. Because a complete address is necessary, the source of the communication must often resort to time-consuming efforts to obtain a complete address. For example, a person who knows seven digits (exchange and line) of a telephone number and the city or state must often obtain the area code from an information service to obtain the complete address.

What is needed is a system that will determine a precise or accurate address from a partial/incomplete or fuzzy address and complete a communication initiated with the fuzzy address using the precise address.

### SUMMARY OF THE INVENTION

It is an aspect of the present invention to allow a system that requires precise information to function with imprecise or ambiguous information.

It is a further aspect of the present invention to convert unclear and ambiguous information required by or for a system into clear and unambiguous information by disambiguation.

It is an additional aspect of the present invention to determine a complete address from partial or incomplete address or address related information.

It is also an aspect of the present invention to provide a system that will complete a communication to a destination based on partial or incomplete destination information.

It is another aspect of the present invention to provide a system that will complete the sending of an email message in situations where the message would ordinarily fail to be delivered because the destination address is not complete.

The above aspects can be attained by a system that completes a communication initiated with a partial/incomplete or fuzzy destination address. A fuzzy address processor breaks the fuzzy address into the tokens, assigns the tokens to categories and uses the categorized tokens to perform one or more database searches to find records with similar address information. The records found are compared to the original fuzzy address and the record with the closest match is used as the record from which a complete address is obtained. The best match is determined using a distance metric. The complete address is used to forward or send the communication to the destination.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a Fuzzy Address Processor (FAP) within a configuration of a delivery system used to send an email message.

FIG. 2 shows operations of and data from flow associated with the Fuzzy Address Processor.

### DETAILED DESCRIPTION OF THE PREFERRED EMBODIMENTS

Many types of systems require precise information to complete the task to which the system is assigned. For example, an email system needs a precise destination address to which to send a message. Another example is determining a precise identity of an individual as part of a screening process where the precise identity needs to be known before the person is allowed to proceed. The lack of precise information results in the failure of the basic task. For example, an email with an ambiguous destination address results in a transmission failure. As another example, an erroneous computer logon ID and password will traditionally result in a logon failure. The present invention is directed to allowing a system that requires precise information to proceed when the information being supplied is ambiguous or erroneous. That is, the present invention takes imprecise information, such as identification elements that are not clear and are ambiguous and makes the information precise or the identification elements clear and unambiguous. This allows the system requiring the precise information to proceed with its basic task and perform the function for which it is intended. The present invention takes the imprecise or fuzzy information and uses it to complete the required task

Fuzzy addressing or identification is a method/system that creates a precise address or identification by taking a “fuzzy” address or identification (imprecise and ambiguous) and using it to look-up or determine or resolve an accurate or identity (precise and unambiguous) from an information source, such as a database or a user. For the sake of simplicity the invention will be discussed in terms of addressing where identification should be considered an equivalent. The address may be for any addressable communication, such as electronic mail (email), telephone call, or mail, such as a courier package or post office letter. A fuzzy address is an address that can include but is not limited to an address that is partially true and/or partially false, an address in which the address information is incomplete or partial, an address in which the information is in error, an address which may be over or under specified, may include a part of a correct address, and may include information not directly related to the domain of the destination.

The effect of fuzzy address conversion is that we can reach anyone through any kind of communication, based on any general information about an individual, including, for example, their name, telephone number, home/work address, virtual address, etc.

The fuzzy address is preferably made from three data structure type components:

Index Component (IC)

Disambiguation Component (DC)

Other Components (OC) that are optional

In the example discussed below, we use a telephone number for the index component (IC) and an individual's name for the disambiguation component (DC). For the discussion herein, we are considering the problem domain of addressing an email message by converting a fuzzy email address into an accurate email address. Other components (OC) could be the residential address, telephones number, occupation, or other personal or public information not directly related to the domain of email.

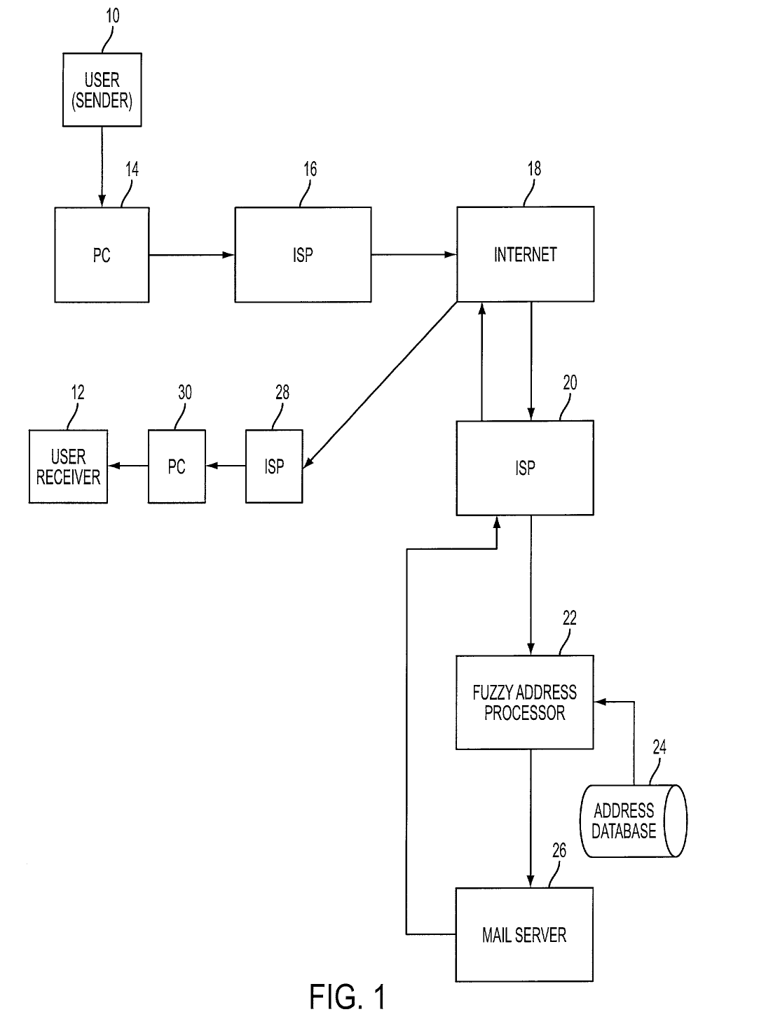

FIG. 1 shows a Fuzzy Address Processor (FAP) within a configuration of a system for sending an email message.

In FIG. 1 a user/sender wants to send someone, a receiver/user 12, an email message. A personal computer (PC) 14 conventionally sends an email with a fuzzy address through an Internet Service Provider (ISP) 16, through the Internet 18 to another ISP 20 that is connected to a Fuzzy Address Processor (FAP) 22. The Fuzzy Address Processor 22 can be conventional server type computer capable of processing email messages having fuzzy addresses as described below. The Fuzzy Address Processor 22 acts as a proxy for the domain of the mail server of the destination for messages with Fuzzy Addresses. The Fuzzy Address Processor 22 is connected to an Address Database 24 and it connects to a Mail Server 26 to provide an ordinary email address that substitutes for the fuzzy address. At this point the address in the fuzzy email in the message is changed to the accurate address. Once the FAP 22 resolves the name, the FAP 22 would contact the correct recipient mail server as if it were the sender and the email message with the accurate address is simply sent (forwarded) to the receiver/user 12 in the usual way using the provided accurate email address to route or deliver the message to the recipient via the remainder of the delivery system including the Internet 18 and the recipient's ISP 28 and PC 30.

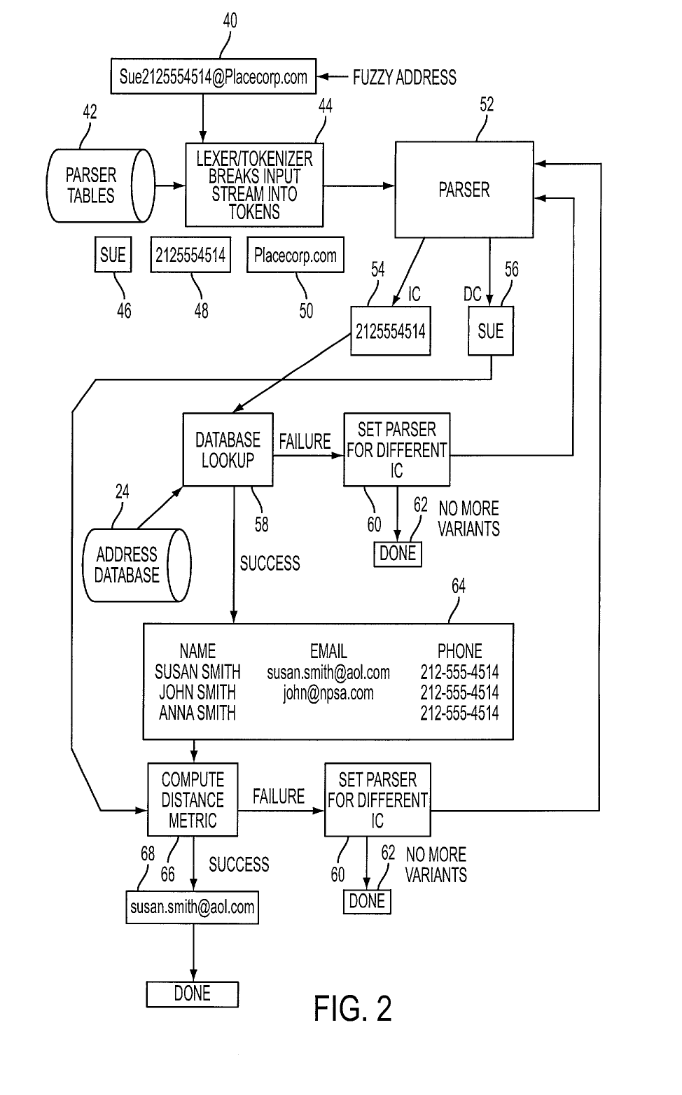

FIG. 2 shows the operations of the Fuzzy Address Processor 22.

The fuzzy email address (FE) is preferably made from the IC with DC either absent (in the case where the IC results in a complete address conversion), before the IC, or after the IC. These items are then preferably followed by a delimiter, such as an “@” symbol, and the domain name (DN) or domain component. Delimiters such as a space ″″ or “#” can also be provided between the IC and DC. The data structure of the fuzzy email address FE could look like: IC@DN, IC#DC@DN or DC#IC@DN. When other components (OC) are part of the ambiguous information, they can also be separated by a delimiter looking like OC IC@DN. The FF needs to be interpreted. To do this, in the most general case, a parsing process is broken up into a lexing or tokenizing phase and a component selection phase. In the tokenizing phase, the input string is divided up into sections based on rules that are created based on the domain of interest. For example, we could create rules that separate everything before/after the “@” into one token. Characters or character groups separated by “#” could also be allocated to different tokens. Other rules would separate each block of letters or numbers into separate tokens. Many rules are possible depending on the expected input string.

As an example, the FE could look like:

Sue 2125554514@placecorp.com

S2125554514@placecorp.com

2125554514Sue@placecorp.com

The algorithm to decode or convert a fuzzy address 40 (see FIG. 2), such as the first one listed above, into an accurate email address is as follows.

The Address Database 24 includes information used to determine the accurate address from the fuzzy address, for example, in an email conversion the Database 24 may have a parser table 42 data structure with fields for Name, Email Address and Telephone Number as shown below.

| Name | Email Address | Telephone Number |
|---|---|---|
| Susan Smith | susan.smith@aol.com | 212-555-4514 |
| John Smith | John@npsa.com | 212-555-4514 |
| Anna Smith | | 212-555-4514 |

The first operation is to tokenize 44 the input string into three components based on the example given above. Sue 2125554514@placecorp.com would be divided into the tokens 46, 48 and 50 shown in FIG. 2.

The next operation 52 is to parse <FE> into <DC>, <IC>, and <OC> by simply assigning the tokens to the appropriate components 54 and 56 as shown in FIG. 2. In this example the DN is OC information and not required to make the address precise.

Then, the FAP 22 finds 58 all records in database with <IC> using a conventional database search process. If this search is not successful (“failure”), the input string is tokenized again 60 with a different setting for the IC unless there are no more variants and the process stops 62.

When address records 64 are found, a Distance Metric (DM) is computed 66 between <DC> and all names in the records 64 found in the Address Database 24.

The record 68 with lowest DM score is chosen. In this example an address for a mailbox in a different domain than the original domain has been found. If this operation does not find a record with a lowest score, the input string is tokenized again 60 with a different setting for the IC.

When a record address is found, the email address of the record is returned and used to route the message as previously discussed.

Of course, the DN can be used in the algorithm as either part of the IC or DC.

An example of DM is a conventional lexical rewrite distance.

As noted above, in the event that the search using the IC does not find any records or the search using DC does not generate a DM that is acceptable, we alter the function of the parser to choose different candidates for IC and DC. In our examples, we could choose to view “Sue” as the IC and the telephone number as the DC. The opposite could be the case. Or the fuzzy address could be broken into more parts, such as text, first three digits and last seven digits with the seven digits being the IC. If the system has tried all the possibilities and still not found acceptable records, the system can then generate an email to the sender with all of the records found based upon the searches asking for clarification. In addition it is possible for the FAP, in the case of a failure because of no more variants and as a part of a request clarification as discussed above, to also suggest possible categories of information that can be helpful to disambiguation, such as name, telephone number, etc. based on the all fields of the database.

As another example of fuzzy address conversion or translation, a user wants to reach a person by telephone and therefore needs an exact telephone number. The user submits a fuzzy address in the form of the name and city and state. In this case the state could be treated as the IC and the city and name could be considered DC. So for example a sender submits to a telephone device an address that might be of the form: “Susan at Staples in New York”. With appropriate tokenizing rules this could be broken into the tokens “Susan”, “Staples”, and “New York”. In this case, the system would have a database of person and company names and phone numbers indexed by state. This would allow a lookup of “Staples” in “New York”. If there were only one “Susan” or “Sue” at the various “Staples” outlets in “New York” then the system can extract that phone number. Otherwise the system can query the sender saying for example “The are six Staples in New York with Susans do you have more information?” The system then uses the last name, city, address or other information to narrow the search.

In a courier package routing example assume that we have a database of valid US street addresses and a fuzzy address on an address label. The parsing process is performed on the address label to extract all available fields. The operation in this case is to select individual fields as the index component and try each looking for selections that yield unambiguous results. The system can take advantage of the fact that addresses are typically over specified. This means that a name and a zip code may in many cases be enough to specify the unique address. In this case if the system chooses the zip code as the IC and name as the DC, the system would end up with a single unique entry into the database.

The present invention has been discussed in the context of index and disambiguation components. In the context of feature space the system knows one dimension in the feature space exactly. We call this dimension the index component. For the other dimensions the system performs a metric calculation to determine the item of interest or the precise information sought. There are two other cases to consider.

One case is the query response case. In the embodiment, the system may or may not have an index component. Instead, the system simply performs a distance calculation to actual elements in the database (aka valid occupied addresses) and then generates a question to the original initiator or submitter, such as the sender of the email, based on the proximities to actual elements. An example would be grapheme rewrite distance. This is defined as the number of editing steps required to get from the fuzzy address to each actual address. The more editing steps the greater the distance. The system uses a threshold like 10 steps and any addresses ten steps away or less would be considered candidates. The system then asks the submitter to choose from among those. Another example might be using other data. For example, if someone asked for “Nat Polish” and there turned out to be two, one in New York and one in California, then they system could (having found a differentiating feature between the two “Nat Polish” entries) ask “New York or California?” or “Which state?” or “Which coast?”.

The other case involves a situation where the information is “fuzzy” in the conventional sense where the information is partially true. In this embodiment, the system deals with the fact that in typical addressing schemes we require that the index or address be graphemically exact. For example, there is one and only one correct way of spelling my name “Nathaniel Polish”. If you misspell it in any way the index lookup with typically fail. Even if you put two spaces between the first and last name the lookup will typically fail. Most lookup schemes require an exact graphemic match. However, the grapheme space (space of all possible addresses or indexes) is likely to be scarce (most possible addresses or indexes are not used). So the system of the present invention creates a unique mapping between the actual address space and the graphemic space. In this case we define a set of rules for doing this mapping. The rules can be complex and depend on factors besides the contents of the fuzzy address. An example of rules using other factors than the fuzzy address itself is discussed below. For example, when comparing a fuzzy address with possible actual addresses, the rules would consider the frequency of request. So if “Nat Polish” might map to “Nathaniel Polish” or “Nate Polish” but “Nathaniel Polish” has been accessed more often than “Nate Polish” then the system preferentially selects “Nathaniel Polish”. In any event the system can form a mapping for fuzzy addresses to exact addresses using whatever rules desired. In the event that the system has two or more possible mappings that can not otherwise differentiated then the system can differentiate randomly or if possible within the confines of the system design, the system can ask the submitter for more data as previously discussed.

The present invention has been described with respect to the components of the information being made available or input substantially simultaneously and from the same input channel, such as when an email is being sent. It is possible for the information to be separately provided both with respect to time and input channel.

The Fuzzy Address Processor 22 has been described as acting as a proxy for the domain of the mail server of the destination. However, it can also act as special service processor of the ISP 16 of the message source resolving the fuzzy address in association with the source ISP 16.

It is also possible for the invention to perform a general database lookup where the index is the fuzzy address and the unambiguous address is the actual record in the database.

It is possible for a reply type message to be optionally sent to the sender when there is resolution or error correction success where the reply message would include the resolved or corrected address in a message suggesting that the sender can update the fuzzy address of the destination in the senders address book with the resolved actual address.

The system could also optionally send a message to the sender, before the fuzzy address message is forwarded with the actual address, asking the sender to confirm whether the unambiguous destination address appears to be correct and/or giving the sender the option to approve or disapprove sending to the substitute address.

Examples for the resolution of destinations for physical address, telephone number or network address, virtual address, and person name have been provided. Other types of address-like or identification resolution can be performed.

Several different types of information that can be used to clear up an ambiguous identification or address have been discussed. Many other types of information could be used; for example, a GPS location can be used to resolve a fuzzy street address.

The discussion herein emphasizes performing a look-up, search or requesting clarification to determine a precise address or identification. It possible to determine an unambiguous address or identification by other methods, such as an algorithmic computation.

The present invention has bee described with respect to resolving ambiguous information. The present invention, can also correct information that is in error. For example, when erroneous email address information is “simon@paceco.com”, a database search up using “simon” as the DC and “paceco” as the IC could search for possible matches and retrieve paul@paceco.com, robin@paceco.com and shimon@paceco.com. A best match based on the lexical distance selects shimon@paceco.com, which replaces the erroneous address allowing the email message to be delivered when ordinarily there would be delivery failure.

The present invention has been described in terms of resolving imprecise information for addressing. The system can also be used to facilitate other tasks. For example, the invention can be applied to a computer-based task, such as a logon. The logging-on to a computer, network or other system typically requires that the user enter an identifier (ID) and security information, such as a password. If this information is incorrect, the system will deny access to the user. With the present invention the user could complete a logon task with a computer system even though the user logon ID and logon password (as the DC) may be ambiguous or incorrect when additional information, such as the maiden name of the mother of the user, is entered as the IC and it can be used to find (correct or disambiguate) the correct logon information. As another example, the present invention can be applied to fault recovery. Normally a system (for example an office network system) ties together many disparate components in a network containing many elements. A common problem is that a failure manifests with a functional failure such as “can not print” while the underlying causes may be complex and poorly determined such as “router 7 is 99% busy” or “cable 23 is experiencing high error rates”. Typically, such devices generate many error and status messages in the normal course of operation. Managing and correlating these messages is a significant and difficult task. In one application of the present invention, the IC is the unambiguous fact that “printer is broken”. The DC is the set of error messages from devices on the network. If there is only one possible cause of the printer being down then things are simple. If, however, the printer being down could indicate any of several possible problems then the DC will resolve which element is the problem. Further, if the system of the present invention requires more information it is able to generate a query to the user that would indicate where to consider looking for the fault.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of performing a task requiring precise information, comprising:
receiving imprecise information for the task;
determining precise information from the imprecise information; and
performing the task using the precise information.

2. A method as recited in claim 1, wherein the imprecise information includes an unambiguous component and an ambiguous component, and the determining comprises:
using the unambiguous component to find possible precise component matches for the ambiguous component;
selecting one of the precise component matches; and
combining the one of the precise component matches the unambiguous component as the precise information.

3. A method, comprising:
examining an incomplete destination address;
determining a complete destination address for the incomplete destination address; and
completing a delivery to the destination using the complete destination address.

4. A method as recited in claim 3, wherein the complete destination address is an email address and the completing is performed by an email server.

5. A method as recited in claim 3, wherein the determining corrects an incomplete address that is erroneous.

6. A method as recited in claim 3, wherein the incomplete address is an incomplete email address with a domain and the determining is performed by a fuzzy address processor acting as a proxy for the domain.

7. A method as recited in claim 3, wherein a domain of the address comprises one of a network, a geographical location, individuals, and virtual locations.

8. A method as recited in claim 3, wherein the examining comprises parsing the incomplete destination address into an index component and a disambiguation component.

9. A method as recited in claim 8, wherein the determining comprises searching an address information database having complete destination addresses for information matching the index component and comparing the disambiguation component to corresponding information in the address information database for a best match.

10. A method as recited in claim 9, wherein the comparing comprises computing a distance metric and determining the best match from a distance metric score.

11. A method as recited in claim 10, further comprising assigning the tokens to different components when a complete address is not found and performing the determining again.

12. A method as recited in claim 3, wherein the complete destination address is one of an email address, a geographical address and a telephone number.

13. A method for email delivery, comprising:
examining an incomplete destination email address in a proxy server for a destination domain by parsing the incomplete destination address into an index component and a disambiguation component;
determining a complete destination email address for the incomplete destination address using a fuzzy address processor by:
searching an address information database having complete destination addresses for information matching the index component;
comparing the disambiguation component to corresponding information in the address information database for a best match by computing a distance metric score;
attempting to determine the best match from the distance metric score; and
requesting user selection among matches when a best match is not determined;
completing a delivery of an email message to the destination using the complete email destination address using a mail server; and
initiating correction of an address book containing the incomplete destination email address with the complete email destination address.

14. A computer readable storage controlling a computer by via a data structure comprising an index component associated with a disambiguation component.

15. A computer readable storage as recited in claim 14, wherein the data structure further comprises a domain component and delimiters separating the components

16. A system, comprising:
a delivery system having a source and a destination with the source providing an incomplete destination address for a delivery; and
a fuzzy address processor determining a complete destination address from the incomplete destination address and initiating a delivery to the destination using the complete destination address.

17. A computer readable storage controlling a computer by via examining an incomplete destination address; determining a complete email destination address for the incomplete destination address and delivering a message using the complete email destination address.
